(19) United States
(12) Patent Application Publication
(10) Pub. No.: US 2025/0010544 A1
(43) Pub. Date: Jan. 9, 2025

(54) POWDER LAYING MECHANISM, AN ADDITIVE MANUFACTURING EQUIPMENT, AND A POWDER LAYING METHOD

(71) Applicant: HON HAI PRECISION INDUSTRY CO., LTD., New Taipei (TW)

(72) Inventors: SZU-HAI HUANG, New Taipei (TW); PANG-YEN JAO, New Taipei (TW)

(21) Appl. No.: 18/762,717

(22) Filed: Jul. 3, 2024

(30) Foreign Application Priority Data
Jul. 6, 2023 (CN) 202310831292.2

(51) Int. Cl. B29C 64/218; B29C 64/241; B33Y 30/00

(52) U.S. Cl. CPC B29C 64/218; B29C 64/241; B33Y 30/00

(57) ABSTRACT

This application provides a powder laying mechanism, an additive manufacturing equipment, and a powder laying method. Wherein, the powder laying mechanism comprises a stock bin, a powder feeding roller, a driving member and one or more powder pressing rollers. The stock bin is provided with a powder outlet. The powder feeding roller is provided at the powder outlet. The driving member is connected with the powder feeding roller and configured to drive the powder feeding roller to rotate. One of the powder pressing rollers is connected to the powder feeding roller through one transmission assembly, and the powder pressing roller is rotatable under a drive of the powder feeding roller.

### FIELD

The present disclosure relates to field of additive manufacturing technology, and in particular to a powder laying mechanism, an additive manufacturing equipment, and a powder laying method.

### BACKGROUND

When a 3D printing equipment completes an operation of powder dropping, it is necessary to smooth and compact laid powders by a scraper or a roller. Due to a poor compaction effect of the scraper in some powder laying scenes, in order to ensure the compaction effect of roller wheels, powder feeding roller wheels and compaction roller wheels of some existing 3D printing equipment need to be controlled by an independent power source, which makes a structure of a powder laying mechanism more complicated. Thus, there is room for improvement within the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 shows a schematic diagram of a structure of an additive manufacturing equipment of the present application in an embodiment.

FIG. 2 shows a structure diagram of the additive manufacturing equipment in FIG. 1 when powders are laid in a forward direction, where one powder roller of a powder laying mechanism is in a down position and another powder roller is in an up position.

FIG. 3 shows a structure diagram of the additive manufacturing equipment in

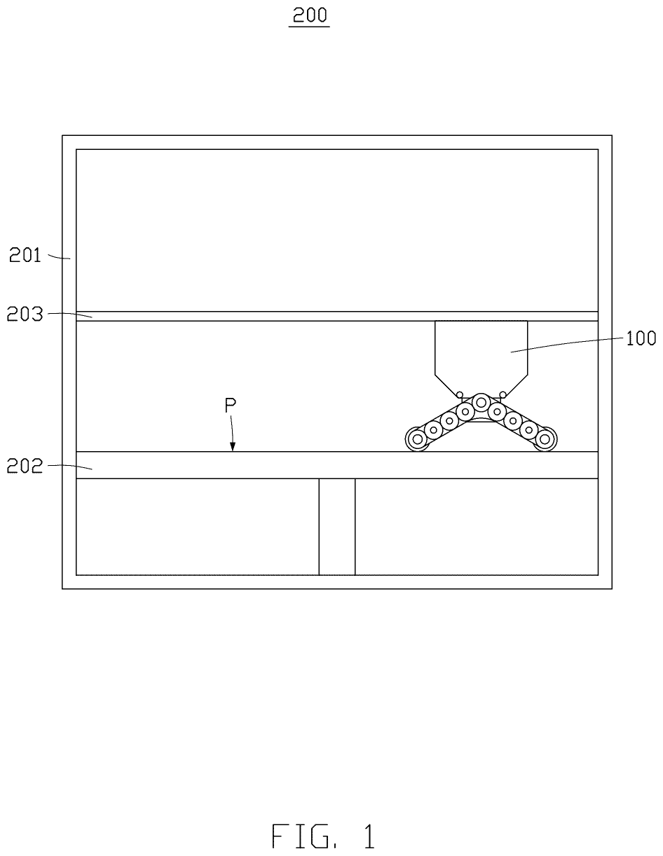

FIG. 1 when powders are laid in a reverse direction, where one powder roller of a powder laying mechanism is in a down position and the other powder roller is in an up position.

FIG. 4 shows a schematic diagram of a structure of a powder laying mechanism of the present application in an embodiment.

FIG. 5 shows a sectional view of the powder laying mechanism in FIG. 4.

FIG. 6 shows an explosive structure diagram of the powder laying mechanism in FIG. 4.

FIG. 7 shows a side view of the powder laying mechanism in FIG. 4.

FIG. 8 shows another sectional view of the powder laying mechanism in FIG. 4.

FIG. 9 shows a front view of the powder laying mechanism in FIG. 4.

FIG. 10 shows an upward view of the powder laying mechanism in FIG. 4.

FIG. 11 shows a top view of the powder laying mechanism in FIG. 4.

### DETAILED DESCRIPTION

In order to make the above-mentioned objects, features and advantages of the present application more obvious, a detailed description of specific embodiments of the present application will be described in detail with reference to the accompanying drawings. A number of details are set forth in the following description so as to fully understand the present application. However, the present application can be implemented in many other ways different from those described herein, and those skilled in the art can make similar improvements without violating the contents of the present application. Therefore, the present application is not to be considered as limiting the scope of the embodiments described herein.

Several definitions that apply throughout this disclosure will now be presented.

The term “coupled” is defined as coupled, whether directly or indirectly through intervening components, and is not necessarily limited to physical connections. The connection may be such that the objects are permanently coupled or releasably coupled. The term “substantially” is defined to be essentially conforming to the particular dimension, shape, or other feature that the term modifies, such that the component need not have that exact feature. The term “comprising,” when utilized, means “including, but not necessarily limited to”; it in one embodiment indicates open-ended inclusion or membership in the so-described combination, group, series, and the like.

Unless otherwise defined, all technical and scientific terms used herein have the same meaning as commonly understood by one skilled in the art. The terms used in a specification of the present application herein are only for describing specific embodiments and are not intended to limit the present application. The terms “and/or” used herein includes any and all combinations of one or more of associated listed items.

Referring to FIG. 1 to FIG. 3, in one embodiment, the additive manufacturing equipment 200 comprises a powder laying mechanism 100, the powder laying mechanism 100 can take into account a simple structural design and ensure a powder laying quality of powders. The following will illustrate by an example.

Referring to FIG. 1, one embodiment provides an additive manufacturing equipment 200. The additive manufacturing equipment 200 comprises a housing 201, a print substrate 202, a powder laying mechanism 100, and a transferring assembly 203. The transferring assembly 203, the print substrate 202, and the powder laying mechanism 100 are arranged in the housing 201. The transferring assembly 203 is connected to the powder laying mechanism 100, and the transferring assembly 203 is configured to drive the powder laying mechanism 100 relative to the print substrate 202, thus laying powders on the print substrate 202. The print substrate 202 provides a powder laying surface P, the powders are laid on the powder laying surface P. The transferring assembly 203 may be a linear motor, a linear cylinder, or other linear driving structure.

Referring to FIG. 4, the powder laying mechanism 100 comprises a stock bin 10, a powder feeding roller 20, a driving member 30, one or more powder pressing rollers 40, and one or more transmission assemblies 50.

The stock bin 10 is provided with a powder storage cavity 11. An opening is defined on a top potion of the powder storage cavity 11. A powder outlet 12 is defined at a bottom of the stock bin 10, and the powder outlet 12 is communicated with the powder storage cavity 11, so that powder materials of the powder storage cavity 11 can be discharged from the powder outlet 12.

Referring to FIG. 5, the powder feeding roller 20 is provided at the powder outlet 12. There is a powder feeding gap G between the powder feeding roller 20 and a wall of the powder outlet 12, the powders in the powder storage cavity 11 can fall from the powder feeding gap G. The powder feeding roller 20 includes a roller body 21, and an outer surface of the roller body 21 is provided with a plurality of powder feeding slots 22. The plurality of powder feeding slots 22 are distributed peripherally. A length direction of each of the powder feeding slots 22 is parallel to a length direction of the powder feeding roller 20. Part of the roller body 21 is received into the powder outlet 12 in a radial direction of the roller body. The powder feeding slots 22 of the part of the roller body 21 stores powders in the powder storage cavity 11. A peripheral surface of the roller body 21 is tangent to two sides of the powder outlet 12 that are relative to the powder outlet 12 and depart from a side of the powder storage cavity 11. When the powder feeding roller 20 stops working, the peripheral surface of powder feeding roller 20 abuts against the two sides of the powder outlet 12, thus sealing the powder outlet 12 to keep powders in the powder storage cavity 11. During a rotation of the powder feeding roller 20, the powder feeding slots 22 defined in a part of the powder feeding roller 20 received in the powder outlet 12 gradually rotates out of the powder storage cavity 11, and powders in the powder feeding slots 22 is discharged, thus completing a powder dropping operation. The powder feeding slots 22 of a part of the powder feeding roller 20 located outside the powder outlet 12 gradually rotates into the powder outlet 12 and receives powders in the powder storage cavity 11, thus completing a powder receiving operation, so as to discharge powders after the powder feeding slots 22 rotating to the outside of the powder storage cavity 11. Therefore, a continuous rotation of the powder feeding roller 20 can achieve an uninterrupted powder laying operation of powders. In one embodiment, a powder receiving capacity of the powder feeding slots 22 of different powder feeding rollers 20 is different, which can be adapted in different shapes of the powder feeding slots 22, and different sizes of the powder feeding slots 22. Therefore, different powder feeding rollers 20 can be replaced according to actual powder feeding needs. In addition, by obtaining the powder receiving capacity of the powder feeding slots 22 defined on the powder feeding roller 20, a distribution of multiple powder feeding slots 22 on the powder feeding roller 20, and a rotation speed of the powder feeding roller 20, a real-time powder feeding capacity of the powder feeding roller 20 can be obtained. In addition, a rotation speed of the powder feeding roller 20 can also be adjusted according to required powder feeding amounts.

The driving member 30 is connected with the powder feeding roller 20, and the driving member 30 is configured to drive the powder feeding roller 20 to rotate. In one embodiment, the driving member 30 includes and is not limited to a motor.

Each one of multiple powder pressing rollers 40 is connected to the powder feeding roller 20 through one or more transmission assemblies 50, and the powder pressing roller 40 can rotate under a drive of the powder feeding roller 20.

When the powder laying mechanism 100 of one embodiment works, the driving member 30 drives the powder feeding roller 20 to rotate, and the powder feeding roller 20 rotate synchronously, powders in the stock bin 10 are discharged from the powder outlet 12, thus completing a powder dropping operation. In a process of a rotation of the powder feeding roller 20, the transmission assembly 50 drives the powder feeding roller 20 to rotate. After powders falls into the powder laying surface P, the rotating powder feeding roller 20 can flatten powders and make powders flowing, thereby improving a uniformity of powders under a pressure, and improving a powder density, and then improving a powder laying quality. A forming quality of an additive manufacturing forming layer is improved. Power sources of the powder feeding roller 20 and the powder pressing roller 40 are from a same driving member 30, which saves a number of power sources of the powder laying mechanism 100 and reduces a cost of the powder laying mechanism 100, so that the powder laying mechanism 100 does not need to set another power source and transmission mechanism to drive the powder feeding roller 20 to rotate. Therefore, the powder laying mechanism 100 of one embodiment applies a simple structural design and guarantees a powder laying quality of powders.

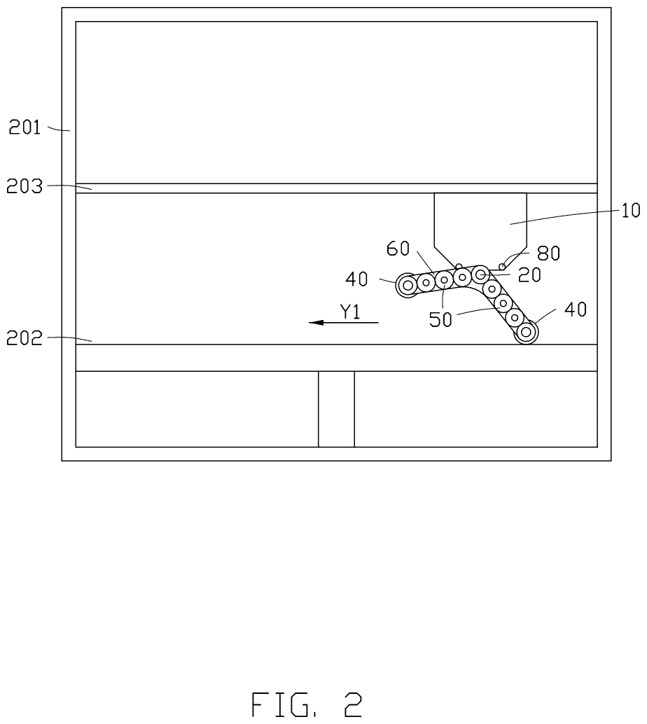

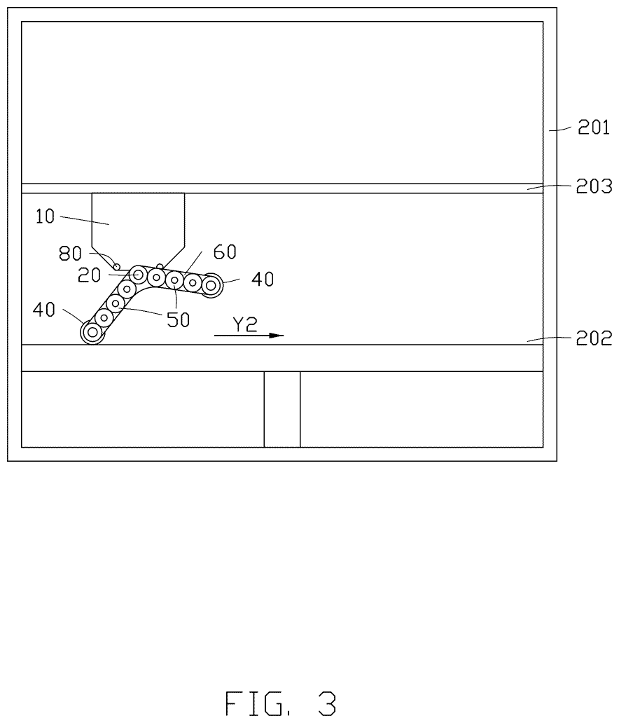

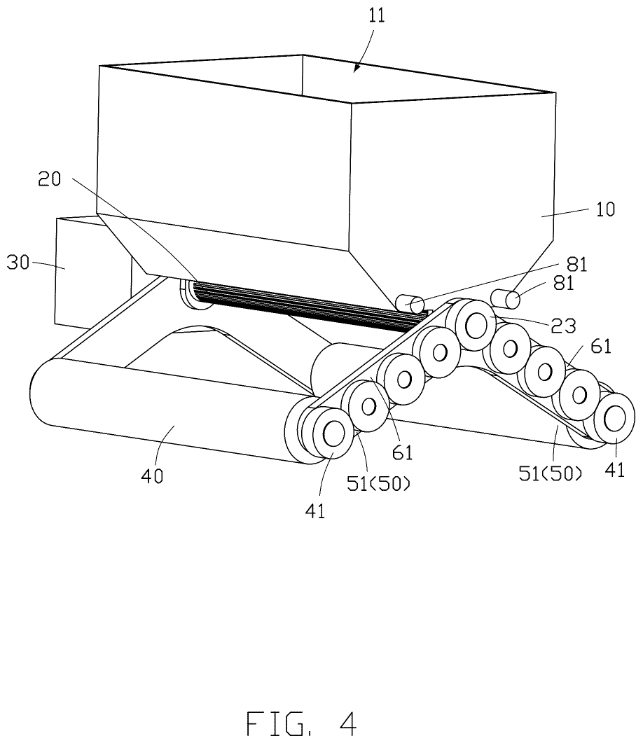

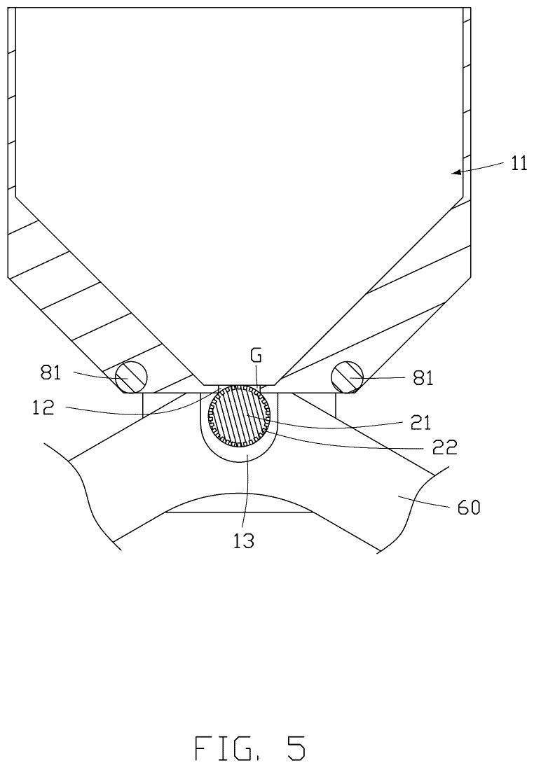

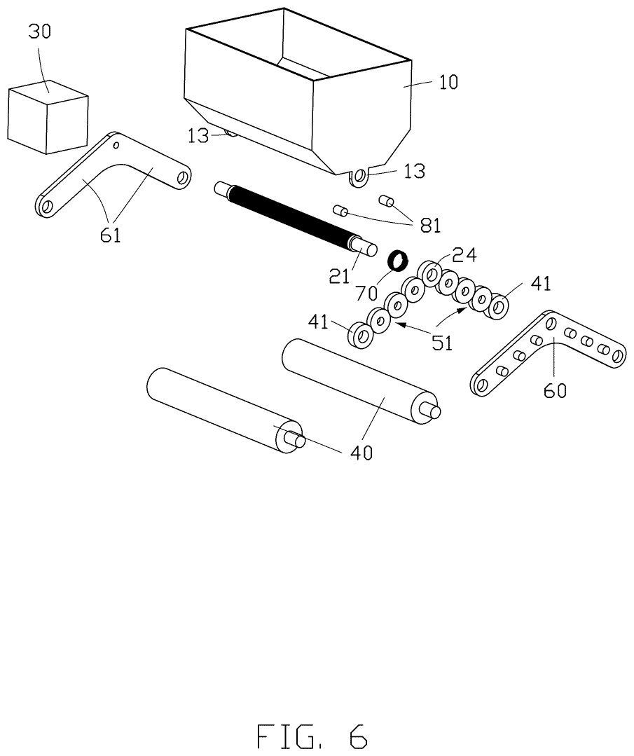

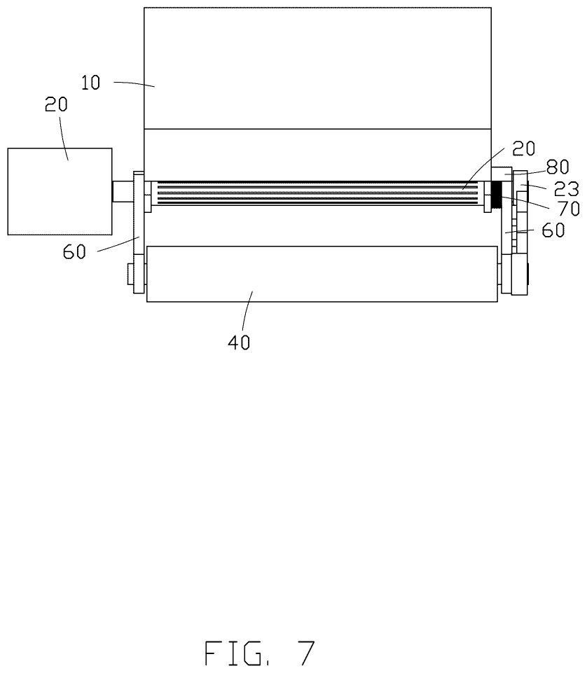

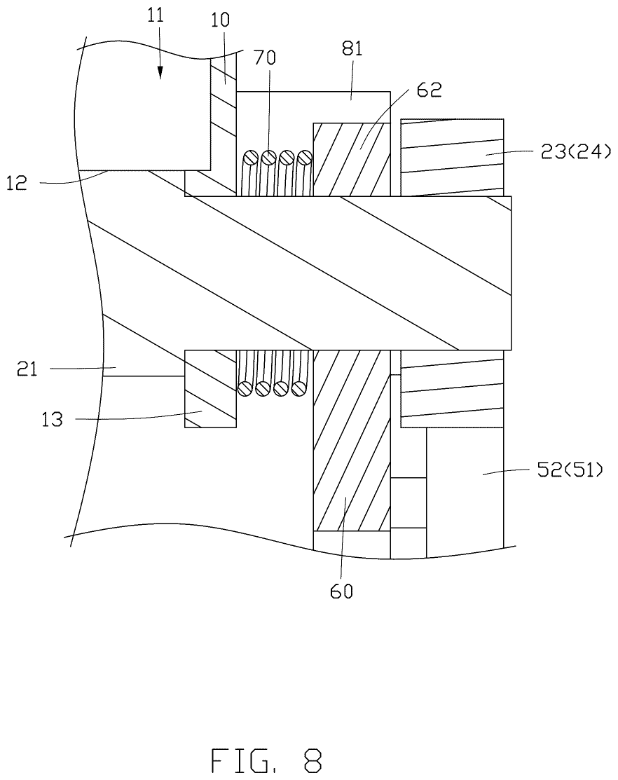

Further, referring to FIG. 2 to FIG. 4, the powder pressing roller 40 is provided with two, and two powder pressing rollers 40 are respectively arranged on both sides of the powder outlet 12. The transmission assembly 50 is provided with two, and one powder pressing roller 40 is connected to the powder feeding roller 20 by one transmission assembly 50, the other powder pressing roller 40 is connected to the powder feeding roller 20 by the other transmission assembly 50.

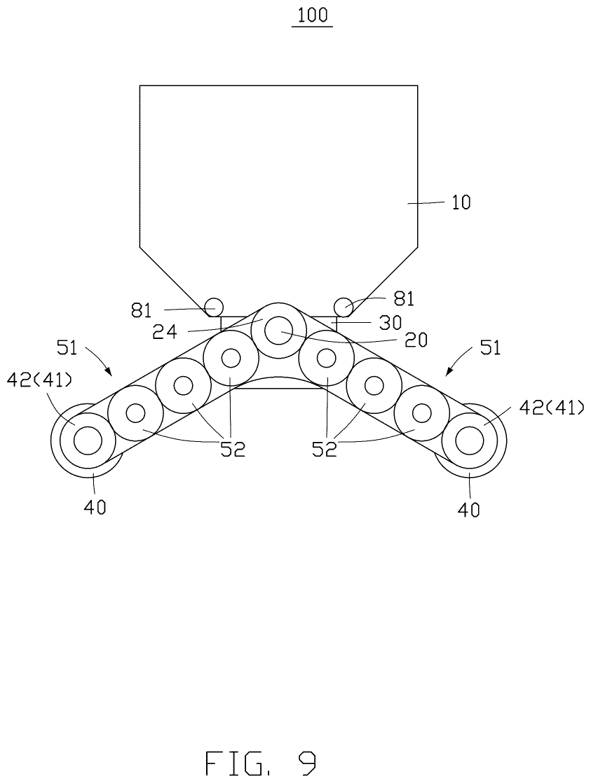

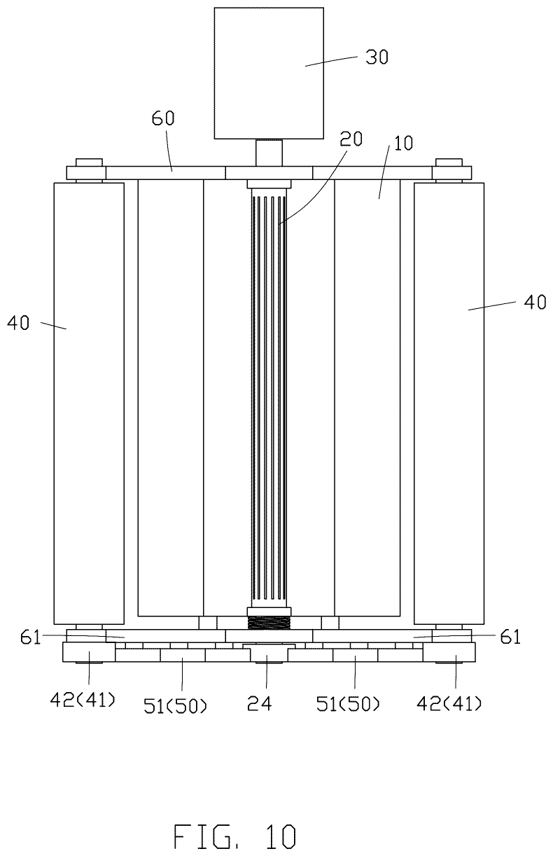

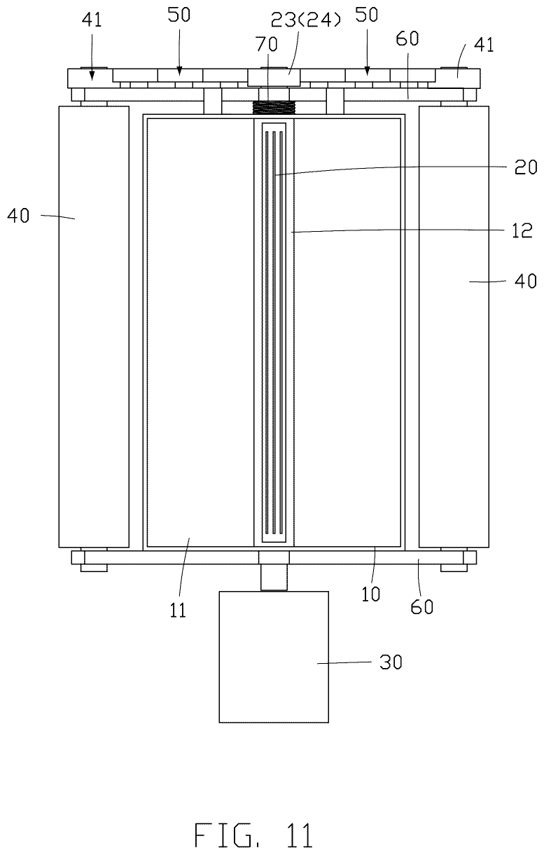

Referring to FIG. 2, when the powder laying mechanism 100 moves in a forward direction Y1, powders laid by the powder feeding roller 20 is compressed in the forward direction Y1 by the powder pressing roller 40 located behind the powder outlet 12 (i.e., the powder pressing roller 40 on a right side of FIG. 2). Referring to FIG. 3, when the powder laying mechanism 100 moves in a reverse direction Y2, powders laid again by the powder feeding roller 20 is compressed by the powder pressing roller 40 located behind the powder outlet 12 in the reverse direction Y2 (i.e., the powder pressing roller 40 on a left side of FIG. 3). Thus, when the powder laying mechanism 100 reciprocates from both sides of the print substrate 202, one layer of powders can be compacted with each movement, thus further improving a powder laying efficiency.

Referring to FIG. 4 to FIG. 6, in one embodiment, the powder laying mechanism 100 further includes a powder laying arm 60. The powder laying arm 60 is V-shaped. A corner of the powder laying arm 60 is connected to the powder feeding roller 20. The two powder pressing rollers 40 are rotationally connected to two ends of the powder laying arm 60, and the powder laying arm 60 can be driven by a rotation of the powder pressing roller 40. Thus, any one of the two powder pressing rollers 40 moves to a dropping position away from the powder feeding roller 20, and the other one of the two powder pressing rollers 40 moves to an upturn position near the powder feeding roller 20.

When one of the two powder pressing rollers 40 is in the dropping position, the one of the two powder pressing rollers 40 is away from the powder feeding roller 20 and close to the print substrate 202, so as to compact powder materials of the print substrate 202. The other one of the two powder pressing rollers 40 is in the upturn position, the other one of the two powder pressing rollers 40 is close to the powder feeding roller 20 and away from the print substrate 202, so as to avoid a movement of the powder laying mechanism 100. The two powder pressing rollers 40 interfere with a powder laying operation and a powder pressing operation. Positions of the two powder pressing rollers 40 can be switched through the powder laying arm 60 to ensure that when the powder laying mechanism 100 moves in the forward direction Y1 or the reverse direction Y2, only one of the two powder pressing rollers 40 in the dropping position can complete a powder compaction operation. In other embodiments, two powder laying arms 60 may be a same length or different lengths.

Referring to FIG. 4, in one embodiment, the powder laying arm 60 comprises two connecting arms 61, the two connecting arms 61 are connected. An angle R is defined between the two connecting arms 61, so that the powder laying arm 60 forms a V-shape.

Referring to FIG. 4 to FIG. 6, in one embodiment, a number of the powder laying arm 60 is provided with two. In a length direction of the powder feeding roller 20, two powder laying arms 60 are respectively connected to both ends of the powder feeding roller 20 to provide a stable and reliable support to the powder feeding roller 20. In other embodiments, if only one powder laying arm 60 is provided, a stable support of the powder feeding roller 20 can also be achieved by lengthening a size of the powder laying arm 60 in a length direction of the powder feeding roller 20.

Referring to FIG. 7 to FIG. 8, in one embodiment, the powder laying arm 60 is rotationally connected to the powder feeding roller 20. The powder laying mechanism 100 further comprises an elastic member 70, the elastic member 70 abuts the powder laying arm 60 against the powder feeding roller 20, so that the powder laying arm 60 can rotate with the powder feeding roller 20 under an action of a friction between the powder feeding roller 20 and the powder laying arm 60.

When the driving member 30 does not drive the powder feeding roller 20, the elastic member 70 abuts the powder laying arm 60 against the powder feeding roller 20, and the powder laying arm 60 exerts an elastic force on the powder feeding roller 20. The elastic force is perpendicular to a contact surface between the powder laying arm 60 and the powder feeding roller 20, and the elastic force generates a friction on a contact surface between the powder laying arm 60 and the powder feeding roller 20. After the driving member 30 drives the powder feeding roller 20 to rotate, the powder feeding roller 20 can drive the powder laying arm 60 to rotate synchronously through the friction force. After the powder laying arm 60 is turned to a powder pressing roller 40 to enter the dropping position, a force may be applied to the powder laying arm 60 in a direction different from that of the friction force, and a component of the force in a direction opposite to the friction force is greater than that of the friction force. Therefore, the friction force cannot drive the powder laying arm 60 to continue to rotate, and the driving member 30 can still drive the powder feeding roller 20 to rotate and complete a powder dropping operation, while the powder laying arm 60 is kept in a state where the powder pressing roller 40 is in the dropping position. The powder feeding roller 20 can also drive the powder pressing roller 40 through the transmission assembly 50, so that the powder pressing roller 40 can better perform a powder pressing operation. Therefore, through a clever design of the elastic member 70, the powder laying arm 60 and the powder feeding roller 20, a power output of the driving member 30 can also synchronously drive the powder laying arm 60 to rotate, thus achieving multiple uses of a driving force output of the driving member 30 and further simplifying an overall structure of the powder laying mechanism 100.

In one embodiment, the elastic member 70 is a spring. In other embodiments, the elastic member 70 may also be an air spring or an elastic sleeve. In other embodiments, a small motor may also be provided in the stock bin 10, an output end of the small motor is provided with a press block. When the powder laying arm 60 needs to be rotated, the small motor is controlled to push the press block straight to abut against the powder feeding roller 20. A cost of the small motor is low.

Referring to FIG. 6 to FIG. 8, in one embodiment, the stock bin 10 is provided with one or more connecting members 13. The powder feeding roller 20 is arranged through one of the one or more connecting members 13, the powder feeding roller 20 is provided with a resisting portion 23. In an axis direction of the powder feeding roller 20, the resisting portion 23 and one of the one or more connecting members 13 are arranged at a distance. The powder laying arm 60 is located between the resisting portion 23 and the one of the connecting members 13. The elastic member 70 is supported by the powder laying arm 60 and the one of the connecting members 13, and the elastic member 70 makes the powder laying arm 60 to abut against the resisting portion 23.

In one embodiment, the elastic member 70 is arranged on a periphery of the powder feeding roller 20, thereby an installation stability of the elastic member 70 is improved, and there is no need to set a fixed structure of the elastic member 70, and an overall structure of the powder laying mechanism 100 is simplified. One of the connecting members 13 facilitates an installation of the powder feeding roller 20. In other embodiments, if the powder feeding roller 20 is installed in the stock bin 10, the one or more connecting members 13 may not be required so that the elastic member 70 is supported between the powder laying arm 60 and the stock bin 10.

Referring to FIG. 8, in one embodiment, the powder laying arm 60 is provided with a matching through hole 62, and the powder feeding roller 20 is arranged in the matching through hole 62. In one embodiment, a peripheral surface of the powder feeding roller 20 is fitted to a surface of the matching through hole 62, so as to ensure that the powder laying arm 60 is not prone to shake up and down when the powder feeding roller 20 drives the powder laying arm 60 to rotate, thus ensuring that the dropping position of the powder pressing roller 40 is accurate and reliable.

In one embodiment, as shown in FIG. 6, a number of the connecting members 13 is provided with two, and in an axis direction of the powder feeding roller 20, two connecting members 13 are respectively arranged at two ends of the stock bin 10. Two ends of the powder feeding roller 20 are respectively connected to the two connecting members 13, so that the powder feeding roller 20 is stably and reliably supported by the two connecting members 13. In other embodiments, only one connecting member 13 may be provided, and single connecting member 13 can stably support the powder feeding roller 20 by increasing its dimensions in an axis direction of the powder feeding roller 20.

In other embodiments, the powder feeding roller 20 may also be provided without a resisting portion 23, so that a gap is provided between the matching through hole 62 and the powder feeding roller 20, and the elastic member 70 such as an elastic sleeve is set at the gap. The elastic sleeve is connected between a surface of the matching through hole 62 and an outer surface of the powder feeding roller 20, so that the elastic sleeve can also provide a friction between the powder feeding roller 20 and the powder laying arm 60, so that a rotation of the powder feeding roller 20 drives the powder laying arm 60 to rotate.

Referring to FIG. 9 to FIG. 11, in one embodiment, the resisting portion 23 is connected with two transmission assemblies 50, which is configured to transmit a rotation of the powder feeding roller 20 to the powder pressing roller 40 to drive the powder pressing roller 40 to rotate. By matching the resisting portion 23 with the two transmission assemblies 50, there is no need to set a structure of the powder feeding roller 20 with the two transmission assemblies 50, which can further simplify an overall structure of the powder feeding roller 20 and reduce processing difficulties. In other embodiments, according to specific structural settings of the two transmission assemblies 50, an additional transmission structure can also be provided at the powder feeding roller 20 and matched with the two transmission assemblies 50.

Referring to FIG. 9 to FIG. 10, in one embodiment, each one of the two powder pressing rollers 40 is connected with a rotating portion 41, and the two transmission assemblies 50 is matched separately with one of two rotating portion 41, so as to drive one of the two rotating portions 41 under a drive of the resisting portion 23, and then drive the one of the two powder pressing rollers 40 to rotate.

Referring to FIG. 9 to FIG. 10, in one embodiment, the resisting portion 23 includes a first rotating gear 24. The rotating portion 41 includes a second rotating gear 42. The transmission assembly 50 includes a gear group 51. The gear group 51 is engaged with the first rotating gear 24 and the second rotating gear 42.

Referring to FIG. 9 to FIG. 10, in one embodiment, the gear group 51 comprises an odd number of transmission gears 52, the transmission gears 52 are engaged sequentially so that a rotation direction of the first rotating gear 24 is the same as a rotation direction of the second rotating gear 42. When the powder feeding roller 20 drives the first rotating gear 24 to rotate clockwise, the powder laying arm 60 rotates clockwise, so that one of the two powder pressing rollers 40 on the right in FIG. 9 moves to the dropping position. At this time, the powder laying mechanism 100 moves in the forward direction Y1, so that the one of the two powder pressing rollers 40 on the right can compact a powder output by the powder feeding roller 20. A rotation direction of the one of the two powder pressing rollers 40 on the right is the same as a rotation direction of the second rotating gear 42, and the rotation directions both are clockwise, which can improve pressing qualities of powders. When the powder feeding roller 20 drives the first rotating gear 24 to rotate counterclockwise, the powder laying arm 60 rotates counterclockwise, so that the other one of the two powder pressing rollers 40 on the left in FIG. 10 moves to the dropping position. At this time, the powder laying mechanism 100 moves in the reverse direction Y2, so that the other one of the two powder pressing rollers 40 on the left can compact a powder output by the powder feeding roller 20. A rotation direction of the other one of the two powder pressing rollers 40 on the left is the same as a rotation direction of the second rotating gear 42, and the rotation directions both are counterclockwise, which can improve pressing qualities of powders. In one embodiment, by adjusting a number of transmission gears 52 of the gear group 51, a space between the powder feeding roller 20 and the two powder pressing rollers 40 can also be adjusted, so as to facilitate an application of different powder laying scenarios, thereby increasing an application range of the powder laying mechanism 100.

In other embodiments, the gear group 51 may include an even number of transmission gears 52, which are sequentially engaged.

In other embodiments, the resisting portion 23 and each one of the two rotating portions 41 may be provided as a synchronous wheel respectively, and each one of the two the transmission assemblies 50 may be provided as a synchronous belt wheel assembly connected between two synchronous wheels. The synchronous belt wheel assembly achieves a transmission function, and a rotation direction of the resisting portion 23 and a rotation direction of each one of the two rotating portions 41 can be consistent.

Referring to FIG. 9, in one embodiment, the powder laying mechanism 100 further includes a limiting structure 80, the limiting structure 80 is configured to limit a rotation limit position of the powder laying arm 60. In the rotation limit position of the powder laying arm 60, one of the two powder pressing rollers 40 is maintained in the upturn position and the other one of the two powder pressing rollers 40 is maintained in the dropping position. The limiting structure 80 can exert a force on the powder laying arm 60, so that the powder feeding roller 20 can overcome a friction between the powder laying arm 60 and the powder feeding roller 20 under an action of the driving member 30, and the powder feeding roller 20 can continue to rotate and drive the powder pressing roller 40, and the powder feeding roller 20 can continue to exert a force on the powder laying arm 60, so as to keep the powder laying arm 60 in the limit position, so as to keep one of the two powder pressing rollers 40 in the dropping position, so as to avoid the one of the two powder pressing rollers 40 warping during a compaction process.

Referring to FIG. 9, in one embodiment, the limiting structure 80 includes two limiting parts 81, the two limiting parts 81 are arranged in the stock bin 10. The two limiting parts 81 respectively correspond to two connecting arms 61. Any one of the two connecting arms 61 rotates to a position to prop up the limiting part 81 corresponding to the one of the two connecting arms 61 and causes the powder pressing roller 40 connected to the one of the two connecting arms 61 to enter the upturn position, the other one of the two connecting arms 61 rotates to the powder pressing roller 40 connected to the other one of the two connecting arms 61 enters the dropping position. In one embodiment, each one of the two limiting parts 81 is provided with a side projection from the stock bin 10. Each one of the two limiting parts 81 may be arranged on a side of the connection arm 61 away from the print substrate 202. In other embodiments, the two limiting parts 81 may also be connected to the stock bin 10, and the two limiting parts 81 are located on a side of the connection arm 61 near the print substrate 202.

In other embodiments, the limiting structure 80 may be a limiting bar, the limiting bar is arranged on a side of the stock bin 10. A length direction of the limiting bar is parallel to a surface of the print substrate 202. When the powder laying arm 60 is rotated, one of the two connecting arms 61 can be moved to a position to prop up one of two ends of the limiting bar, so that the powder laying arm 60 is limited to the limit position.

In other embodiments, the limiting structure 80 may be an electromagnet, the electromagnet is arranged on a side of the stock bin 10, and a magnet or an iron block is provided on each one of the two connecting arms 61, so that the powder laying arm 60 can be rotated by a suction force between the electromagnet and the magnet or the iron block, and one of the two connecting arms 61 is maintained at the limit position.

One embodiment further provides a powder laying method based on the powder laying mechanism 100, the powder laying method comprises: controlling the stock bin 10 to move in a forward direction Y1; controlling the driving member 30 to drive the powder feeding roller 20 to rotate forward, the powder feeding roller 20 drives the powder laying arm 60 to rotate, so that one of two powder pressing rollers 40 enters the upturn position, another powder pressing roller 40 enters the dropping position, and the powder outlet 12 is located on a side of the powder pressing roller 40 in the dropping position along a positive direction Y1; the powder feeding roller 20 rotates and drives powders in the stock bin 10 to fall from the powder feeding gap G to the powder laying surface P, and the powder pressing roller 40 located at the dropping position rotates to smooth the powder laying surface P; then controlling the stock bin 10 to move in a reverse direction Y2, the reverse direction Y2 is opposite to the forward direction Y1; controlling the driving member 30 to drive the powder feeding roller 20 to reverse rotate, the powder feeding roller 20 drives the powder laying arm 60 to rotate, so that one of two powder pressing rollers 40 enters the upturn position, another powder pressing roller 40 enters the dropping position, and the powder outlet 12 is located on a side of the powder pressing roller 40 in the dropping position along the reverse direction Y2; the powder feeding roller 20 rotates and drives powders in the stock bin 10 to fall from the powder feeding gap G to the powder laying surface P, and the powder pressing roller 40 located at the dropping position rotates to smooth the powder laying surface P.

A laying operation of powders can be performed by the laying method in one embodiment, and a laying efficiency of the powder laying mechanism 100 can be improved by laying powders once during a round trip movement of the powder laying mechanism 100, and one of the two powder pressing rollers 40 is provided in each laying process to compact powders, so as to ensure a laying quality of powders and finally improve a printing efficiency and a printing quality.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A powder laying mechanism, comprising:
a stock bin, provided with a powder outlet,
a powder feeding roller, provided at the powder outlet,
a driving member, connected with the powder feeding roller, and the driving member being configured to drive the powder feeding roller to rotate, and
one or more powder pressing rollers, connected to the powder feeding roller through one or more transmission assemblies, and the powder pressing roller being rotatable under a drive of the powder feeding roller.

2. The powder laying mechanism as claimed in claim 1, wherein, the powder pressing roller is provided with two, and two powder pressing rollers are respectively arranged on both sides of the powder outlet; the transmission assembly is provided with two, and two powder pressing rollers are respectively connected with the powder feeding roller through two transmission assemblies.

3. The powder laying mechanism as claimed in claim 2, wherein, the powder laying mechanism further comprises a powder laying arm, the powder laying arm is V-shaped, a corner of the powder laying arm is connected to the powder feeding roller, two powder pressing rollers are respectively rotationally connected to both ends of the powder laying arm, the powder laying arm can be driven by a rotation of the powder pressing roller, to make one of the two powder pressing rollers enters a dropping position away from the powder feeding roller, and the other one of the two powder pressing rollers enters an upturn position near the powder feeding roller.

4. The powder laying mechanism as claimed in claim 3, wherein, the powder laying arm is rotationally connected with the powder feeding roller; the powder laying mechanism further comprises an elastic member, the elastic member abuts the powder laying arm against the powder feeding roller thereby making the powder laying arm rotates with the powder feeding roller under a friction force between the powder feeding roller and the powder laying arm.

5. The powder laying mechanism as claimed in claim 4, wherein, the stock bin is provided with a connecting member; the powder feeding roller is arranged on the connecting member, the powder feeding roller is provided with a resisting portion, in an axis direction of the powder feeding roller, the resisting portion is spaced with the connecting member, the powder laying arm is located between the resisting portion and the connecting member, the elastic member is elastically supported between the powder laying arm and the connecting member, and the elastic member resists against the powder laying arm such that the powder laying arm abuts against the resisting portion.

6. The powder laying mechanism as claimed in claim 5, wherein, the resisting portion is respectively matched with two transmission assemblies, and the resisting portion transmits rotations of the powder feeding roller to the powder pressing roller thereby driving the powder pressing roller to rotate.

7. The powder laying mechanism as claimed in claim 3, wherein, the powder laying mechanism further comprises a limiting structure, the limiting structure is configured to limit a rotation limit position of the powder laying arm, when the powder laying arm is in the rotation limit position, one of the two powder pressing rollers is maintained in an upturn position and the other powder pressing roller is maintained in a dropping position.

8. The powder laying mechanism as claimed in claim 7, wherein, the powder laying arm comprises two connecting arms, the two connecting arms are connected to each other, an angle is defined between the two connecting arms; the limiting structure comprises two limiting parts, the two limiting parts are respectively arranged in the stock bin, the two limiting parts respectively correspond to the two connecting arms, when one of the two connecting arms rotates to a position to prop up the limiting part corresponding to the one of the two connecting arms, the powder pressing roller is connected to the one of the two connecting arms to enter the upturn position, the other one of the two connecting arms rotates to the powder pressing roller connected to the other one of the two connecting arms enters the dropping position.

9. An additive manufacturing equipment, comprising:
a print substrate,
a powder laying mechanism, configured for powder materials to the print substrate, the powder laying mechanism comprises:
a stock bin, provided with a powder outlet,
a powder feeding roller, provided at the powder outlet,
a driving member, connected with the powder feeding roller, and the driving member being configured to drive the powder feeding roller to rotate, and
one or more powder pressing rollers, connected to the powder feeding roller through one or more transmission assemblies, and the powder pressing roller being rotatable under a drive of the powder feeding roller.

10. The Additive manufacturing equipment as claimed in claim 9, wherein, the powder pressing roller is provided with two, and two powder pressing rollers are respectively arranged on both sides of the powder outlet; the transmission assembly is provided with two, and two powder pressing rollers are respectively connected with the powder feeding roller through two transmission assemblies.

11. The Additive manufacturing equipment as claimed in claim 10, wherein, the powder laying mechanism further comprises a powder laying arm, the powder laying arm is V-shaped, a corner of the powder laying arm is connected to the powder feeding roller, two powder pressing rollers are respectively rotationally connected to both ends of the powder laying arm, the powder laying arm can be driven by a rotation of the powder pressing roller, to make one of the two powder pressing rollers enters a dropping position away from the powder feeding roller, and the other one of the two powder pressing rollers enters an upturn position near the powder feeding roller.

12. The Additive manufacturing equipment as claimed in claim 11, wherein, the powder laying arm is rotationally connected with the powder feeding roller; the powder laying mechanism further comprises an elastic member, the elastic member abuts the powder laying arm against the powder feeding roller thereby making the powder laying arm rotates with the powder feeding roller under a friction force between the powder feeding roller and the powder laying arm.

13. The Additive manufacturing equipment as claimed in claim 12, wherein, the stock bin is provided with a connecting member; the powder feeding roller is arranged on the connecting member, the powder feeding roller is provided with a resisting portion, in an axis direction of the powder feeding roller, the resisting portion is spaced with the connecting member, the powder laying arm is located between the resisting portion and the connecting member, the elastic member is elastically supported between the powder laying arm and the connecting member, and the elastic member resists against the powder laying arm such that the powder laying arm abuts against the resisting portion.

14. The Additive manufacturing equipment as claimed in claim 13, wherein, the resisting portion is respectively matched with two transmission assemblies, and the resisting portion transmits rotations of the powder feeding roller to the powder pressing roller thereby driving the powder pressing roller to rotate.

15. The Additive manufacturing equipment as claimed in claim 11, wherein, the powder laying mechanism further comprises a limiting structure, the limiting structure is configured to limit a rotation limit position of the powder laying arm, when the powder laying arm is in the rotation limit position, one of the two powder pressing rollers is maintained in an upturn position and the other powder pressing roller is maintained in a dropping position.

16. The Additive manufacturing equipment as claimed in claim 15, wherein, the powder laying arm comprises two connecting arms, the two connecting arms are connected to each other, an angle is defined between the two connecting arms; the limiting structure comprises two limiting parts, two limiting parts are respectively arranged in the stock bin, the two limiting parts respectively correspond to the two connecting arms, when one of the two connecting arms rotates to a position to prop up the limiting part corresponding to the one of the two connecting arms, the powder pressing roller is connected to the one of the two connecting arms to enter the upturn position, the other one of the two connecting arms rotates to the powder pressing roller connected to the other one of the two connecting arms enters the dropping position.

17. The Additive manufacturing equipment as claimed in claim 15, wherein, the eye tracking component comprises a light emitting member, the light emitting member is electrically connected to the conductive wires via the pads, the light emitting member is configured to emit a first localization ray to an eyeball, the first localization ray is reflected by the eyeball to form a second localization ray, the eye tracking component receives the second localization ray for tracking an eyeball.

18. A powder laying method, based on the powder laying mechanism as claimed in claim 3, the powder laying method comprises:
controlling the stock bin to move in a forward direction,
controlling the driving member to drive the powder feeding roller to rotate forward, the powder feeding roller drives the powder laying arm to rotate, so that one of two powder pressing rollers enters the upturn position, another powder pressing roller enters the dropping position, and the powder outlet is located on a side of the powder pressing roller in the dropping position along a positive direction,
the powder feeding roller rotates and drives powders in the stock bin to fall from a powder feeding gap to a powder laying surface, and the powder pressing roller located at the dropping position rotates to smooth the powder laying surface,
then controlling the stock bin to move in a reverse direction, the reverse direction is opposite to the forward direction,
controlling the driving member to drive the powder feeding roller to reverse rotate, the powder feeding roller drives the powder laying arm to rotate, so that one of two powder pressing rollers enters the upturn position, another powder pressing roller enters the dropping position, and the powder outlet is located on a side of the powder pressing roller in the dropping position along the reverse direction,
the powder feeding roller rotates and drives powders in the stock bin to fall from a powder feeding gap to a powder laying surface, and the powder pressing roller located at the dropping position rotates to smooth the powder laying surface.
